(19) United States
(12) Patent Application Publication
(10) Pub. No.: US 2010/0011766 A1
(43) Pub. Date: Jan. 21, 2010

(54) DEVICE FOR RECOVERING ELECTRICAL ENERGY FROM THE EXHAUST HEAT OF A COMBUSTION ENGINE OF A MOTOR VEHICLE, AND METHOD FOR RECOVERING ELECTRICAL ENERGY FROM THE EXHAUST HEAT OF A COMBUSTION ENGINE OF A MOTOR VEHICLE

(75) Inventors: Andreas Gründl, Starnberg (DE); Bernhard Hoffmann, Starnberg (DE)

Correspondence Address: HISCOCK & BARCLAY, LLP, 2000 HSBC PLAZA, 100 Chestnut Street, ROCHESTER, NY, 14604-2404, US

(73) Assignee: Compact Dynamics GmbH, Starnberg (DE)

(21) Appl. No.: 12/507,888

(22) Filed: Jul. 23, 2009

Related U.S. Application Data
(63) Continuation-in-part of application No. PCT/EP2008/000502, filed on Jan. 23, 2008.

(51) Int. Cl. F02G 3/00; H02K 7/18

(52) U.S. Cl. 60/614; 290/52; 903/906

(57) ABSTRACT

Device for recovering electrical energy from the exhaust heat of a combustion engine of a motor vehicle, with a heat exchanger, through which the exhaust gas of the combustion engine is to flow on the input side, and through which heat exchanger fluid, which in operation of the combustion engine is to be brought in the heat exchanger to a first, high temperature and/or pressure level, is to flow on the output side. The device has at least one Laval nozzle, which has an inlet and an outlet, the inlet of which is to be connected to an output-side outlet of the heat exchanger, the outlet of which is directed onto turbine blade wheels of a constant-pressure turbine, and which is dimensioned so that it loads the constant-pressure turbine with steam which has a lower second temperature and/or pressure level than the first, high temperature and/or pressure level and has a high flow velocity. The device also has an electrical generator, which has a rotor which is coupled to the constant-pressure turbine and is to be put into rotation by it, and a stator with at least one stator winding, at which electrical power is to be taken. The device also has a condensation cooler, which is set up to liquefy steam which has done work on the constant-pressure turbine. Liquid which is obtained from this steam by condensation must be fed into an output-side inlet of the first heat exchanger.

### CROSS-REFERENCE TO RELATED APPLICATIONS

This application is a continuation-in-part of International Application Number PCT/EP2008/000502 filed Jan. 23, 2008.

### DESCRIPTION

The invention concerns a device for recovering electrical energy from the exhaust heat of a motor vehicle. The invention also concerns a method for recovering electrical energy from the exhaust heat of a motor vehicle, and the use of electrical energy recovered from the exhaust heat of a motor vehicle to operate a motor vehicle.

From DE 33 26 992 C1, a drive unit for motor vehicles, equipped with a combustion engine and a waste heat turbine unit, is known. The waste heat turbine unit consists of a gas turbine, to which the exhaust gases of the combustion engine are applied, and a steam turbine. In the waste heat turbine unit, a steam, which is generated by exhaust gas heat from a vaporisable liquid medium, expands, outputting work. The waste heat turbine unit has a rotating cylinder in the form of a hollow body, which carries blades, which are exposed to the exhaust gases, on its outside. Vaporisable liquid medium can be fed into the inside of the cylinder. Steam which is generated there can go from the cylinder into the downstream steam turbine and a housing in which the cylinder and the steam turbine are carried.

From DE 29 41 240 A1, a combustion engine with at least one cylinder which is fixed in the engine, and a piston which is movable in the cylinder and works on a crankshaft, is known. The piston, together with the cylinder, delimits a combustion chamber. The combustion chamber has an inlet valve and an outlet valve. Through the outlet valve, exhaust gas can be fed to a turbine, which is connected to a power generator.

From EP 0 636 779 B1, a heat engine and a method of operating it are known. The heat engine is used to generate thermal and mechanical energy. In the system, the coolant is fed from the engine into a vaporisation chamber, in which part of the coolant is transformed into steam by reducing the pressure or increasing the amount of thermal energy within this chamber. The steam which is generated from the coolant is superheated by means of a hot fluid flow. The coolant steam is used within the energy using system for energy transport or as a medium for energy recovery. The pressure of the coolant is maintained higher in the engine than the pressure in the vaporisation chamber, so that the coolant in the engine is liquid. The amount of energy which is required in the vaporisation chamber to vaporise the coolant essentially corresponds to the amount of thermal energy which is transferred to the coolant from the heat engine while the latter is being cooled.

So that such devices can make a meaningful contribution to reducing fuel consumption in motor vehicles, they must meet a series of requirements. Thus operational safety must be ensured by appropriate construction, and a high degree of efficiency and suitability for economical mass production must be achieved.

It is therefore a feature of one embodiment of the invention to provide a device of the above-mentioned kind, which with low cost, compact design, simple construction and reliable operation makes an improved degree of energy recovery compared with the prior art possible.

That embodiment is a device for recovering electrical energy from the exhaust heat of a combustion engine of a motor vehicle, with a heat exchanger, through which the exhaust gas of the combustion engine is to flow on the input side, and through which heat exchanger fluid, which in operation of the combustion engine is to be brought in the heat exchanger to a first, high temperature and/or pressure level, is to flow on the output side. The device has at least one Laval nozzle, which has an inlet and an outlet, the inlet of which is to be connected to an output-side outlet of the heat exchanger, the outlet of which is directed onto at least one blade of at least one turbine blade wheel of a constant-pressure turbine, and which is dimensioned so that it loads the constant-pressure turbine with steam which has a lower second temperature and/or pressure level than the first, high temperature and/or pressure level and has a high flow velocity. The device also has an electrical generator, which has a rotor which is coupled to the constant-pressure turbine and is to be put into rotation by it, and a stator with at least one stator winding, at which electrical power is to be taken. The device also has a condensation cooler, which is set up to liquefy steam which has done work on the constant-pressure turbine. Liquid which is obtained from this steam by condensation is to be fed into an output-side inlet of the first heat exchanger.

The energy which is obtained with the device according to the invention can be used in a hybrid vehicle in which, in or on the drive train, with a fossil combustion engine or a hydrogen combustion engine, one or more electrical machines are arranged (e.g. regenerative braking or for electrical support or temporary replacement of the combustion engine), to increase the driving power of the vehicle. Alternatively, use as an auxiliary power unit (APU), such as is now mainly used in aircraft, is also conceivable. The APU is not intended to drive the vehicle. It supplies electrical energy for autonomous operation of the vehicle equipment, without the main drive having to run. Other systems on the vehicle which can be operated by the APU are on-board electrical/electronic systems, air conditioning, etc. In this case, the heat exchanger would be operated with a burner (e.g. of auxiliary heating), to obtain a compact unit for auxiliary air conditioning, etc.

The combustion engine of the motor vehicle can be an internal combustion engine in the form of a diesel engine, a petrol engine or similar. The heat exchanger must be connected to the combustion engine of the motor vehicle, and the heat exchanger fluid must flow through the heat exchanger, in such a way that the exhaust gas of the combustion engine and the heat exchanger fluid pass through the heat exchanger in counter-flow.

According to one embodiment of the invention, the inlet of the Laval nozzle must be connected to the output-side outlet of the heat exchanger, with a control valve, which switches depending on pressure and/or temperature, connected between them, the control valve being in its closed position below a predetermined first pressure and/or temperature level. This ensures that the device does not start until operating values defined by the predetermined first pressure and/or temperature level are reached.

When a temperature level of the heat exchanger fluid reaches about 450° C. to 700° C., or its pressure level reaches about 45 bar to about 70 bar, the control valve, which switches depending on pressure and/or temperature, switches from its closed position to its open position. Intermediate values between these given values, and arbitrary combinations of such pressure and temperature values, are considered to be disclosed in the meaning of the invention.

According to another embodiment of the invention, the Laval nozzle can have an essentially circular cross-section, the outlet of the Laval nozzle having an expansion angle which is chosen so that the escaping steam has a flow with no separation from the outlet of the Laval nozzle. However, other cross-sections, e.g. elliptical, are possible for the Laval nozzle.

The expansion angle is preferably under 20°, more preferably under 10°. Also according to the invention, the Laval nozzle can be dimensioned so that the steam which is fed into its inlet is superheated steam (dry steam) at the outlet of the Laval nozzle.

According to a further embodiment of the invention, the constant-pressure turbine can have a turbine blade wheel, which to generate a torque which acts on the rotor of the electrical generator draws energy from the steam. A pressure difference between the inlet of the Laval nozzle and an outlet of the constant-pressure turbine must be relieved practically exclusively in the Laval nozzle, while the pressure in the turbine blade wheel remains practically constant.

According to another embodiment of the invention, the constant-pressure turbine is a Pelton turbine, and the flow through it is preferably tangential.

To regulate the useful electrical power which is generated in the device by changing the volume flow which is directed onto the turbine blade wheel of the constant-pressure turbine, the Laval nozzle can have a nozzle cross-section which can be adjusted with an adjustment device.

Along the circumference of the turbine blade wheel of the constant-pressure turbine, one or more Laval nozzles can be arranged, to direct steam onto the blades of the constant-pressure turbine. For these multiple Laval nozzles, the rules and stipulations explained above about their dimensioning apply. In this embodiment, it is possible to regulate the useful electrical power by feeding steam from the heat exchanger to individual or multiple Laval nozzles, selectively switched.

The constant-pressure turbine is preferably arranged so that its blades are free of tailwater. In the context of the invention, care must be taken that the steam volume flow which is directed onto the blades does not condense on the turbine blade wheel of the constant-pressure turbine.

According to the invention, instead the steam should be precipitated on the condensation cooler. For this purpose, a body which is to be put into rotation is provided as the condensation cooler. This body which is to be put into rotation is arranged in a space which the steam reaches after it has done work on the constant-pressure turbine. In other words, according to the invention, the steam which is used on the constant-pressure turbine remains in the steam phase even after it has done work there, until it reaches the sphere of influence of the condensation cooler. Only there, the steam condenses as precipitation, and can be fed back to the cooling circuit. An key feature of the condensation cooler is that it must be put into rotation. For this purpose, a separate motor can be provided; however, it is also possible to derive the rotation—with its rotational speed reduced if necessary—from the rotor of the constant-pressure turbine.

The condensation cooler can have multiple chambers which are connected to each other for flow, and the walls of which must be cooled on one side by a cooling medium, and on the other side are used as condensation surfaces for the steam from the constant-pressure turbine. Either the steam can be precipitated on the outside of the chambers, and the inside of the chamber walls can be cooled, or the steam can be precipitated on the inside of the chambers, and the outside of the chamber walls is cooled.

Preferably, the chambers of the condensation cooler must be put into rotation at a rotational speed which is dimensioned so that the resulting centrifugal force conveys precipitation which condenses on the condensation surface radially outward to the edges of the chambers, and throws it off radially from there. In this way, the steam can be continuously precipitated on the walls of the chambers, and is transported away from there. This increases the cooling power compared with traditional condensation coolers, even those with strippers, significantly.

To cool the chamber walls of the condensation cooler, a cooling medium, e.g. water, is conveyed along the chamber walls. The thermal energy of this cooling medium is conducted out of the device via a further heat exchanger. For instance, it can be output to the environment via the existing cooling circuit of the motor vehicle, or via a separate cooler which is cooled by natural or forced air flow.

A depression can also be provided, to collect precipitation which is thrown off radially from the edges of the chambers as liquid, so that it is available as heat exchanger fluid for feeding into the output-side inlet of the heat exchanger.

According to one embodiment of the invention, an intake of a feed pump, which conveys the liquid to the output-side inlet of the heat exchanger, can extend into this depression.

The electrical generator can be a permanent-magnet direct current generator, preferably with electronic commutation. However, other, preferably fast running types of electrical generator, e.g. a reluctance generator, can be used in the device according to the invention.

According to another embodiment of the invention, output connections of the stator windings of the electrical generator must be connected to at least one electrical energy store (accumulator) and/or at least one electric motor in or on the drive train of the motor vehicle.

According to a further embodiment of the invention, the device is held in a pressure-resistant and temperature-resistant jacket.

The rotating condensation cooler, in which medium condensing on the cooling walls is thrown off the cooling walls by centrifugal force, is a self-contained invention, which can also be used advantageously in other fields.

Even though the device according to the invention is described above in relation to energy recovery in a motor vehicle, it is understood that the invention can also be used advantageously in stationary applications (e.g. a stationary power generation unit).

Another embodiment of the invention also teaches a method for recovering electrical energy from the exhaust heat of a combustion engine of a motor vehicle, with the following steps:
providing a heat exchanger,
feeding exhaust gas of the combustion engine into the input side of the heat exchanger,
feeding heat exchanger fluid into the output side of the heat exchanger, to bring the heat exchanger fluid in the heat exchanger to a first, high temperature and/or pressure level in operation of the combustion engine,
feeding the heat exchanger fluid at the first, high temperature and/or pressure level to at least one Laval nozzle, which has an inlet for the heat exchanger fluid and an outlet which is directed onto turbine blade wheels of a constant-pressure turbine,
the Laval nozzle being dimensioned so that it loads the constant-pressure turbine with steam which has a lower second temperature and/or pressure level than the first, high temperature and/or pressure level and has a high flow velocity,
to put a rotor (of an electrical generator) which is coupled to the constant-pressure turbine into rotation, and to take electrical power from a stator of the electrical generator with at least one stator winding,
condensing the steam which has done work on the constant-pressure turbine using a condensation cooler, and
feeding the liquid which is obtained by condensing this steam into the output side of the heat exchanger as heat exchanger fluid.

As the combustion engine of the motor vehicle, in this method an internal combustion engine in the form of a diesel engine, a petrol engine or similar is used.

According to one embodiment of the invention, the exhaust gas of the combustion engine and the heat exchanger fluid pass through the heat exchanger in counter-flow.

According to another embodiment of the invention, the inlet of the Laval nozzle is not put into flow connection to the output-side outlet of the heat exchanger until the heat exchanger fluid is above a predetermined first pressure and/or temperature value. Preferably, the inlet of the Laval nozzle is not put into flow connection to the output-side outlet of the heat exchanger until the heat exchanger fluid has reached a temperature level of about 450° C. to 700° C., or a pressure level of about 45 bar to about 70 bar. Specially preferably, a pressure level of about 550° C. and/or a temperature level of about 60 bar is used. It should be understood that all intermediate values of the above-mentioned value ranges are also disclosed as belonging to the invention.

At the outlet of the Laval nozzle, preferably steam is provided essentially in a flow with no separation. For this purpose, according to the invention, at the outlet of the Laval nozzle superheated steam, which preferably has a pressure of about 2-7 bar, a temperature of about 130-250° C., and a flow velocity of about 900-1300 m/s, is provided. It should be understood that all intermediate values of the above-mentioned value ranges are also disclosed as belonging to the invention. Specially preferred are a pressure of about 3 bar, a temperature of about 145° C., and a flow velocity of about 1100 m/s. However, because of (fluid) friction losses and flow losses, a temperature of about 200° C. can be set up.

According to a further embodiment of the invention, to generate a torque which acts on the rotor of the electrical generator, a turbine blade wheel of the constant-pressure turbine draws energy from the steam. A pressure difference between the inlet of the Laval nozzle and an outlet of the constant-pressure turbine is relieved practically exclusively in the Laval nozzle, while the pressure in the turbine blade wheel remains practically constant.

According to still another embodiment of the invention, the steam which the Laval nozzle provides preferably flows through the constant-pressure turbine tangentially.

According to still another embodiment of the invention, to regulate the useful electrical power which the device outputs, the volume flow through the nozzle cross-section of the Laval nozzle can be adjusted with an adjustment device. Alternatively, according to the invention, regulation is also possible via the number of Laval nozzles which are loaded with steam, or by regulating the pressure level of the feed pump of the heat exchanger.

After the steam has done work on the constant-pressure turbine, it is precipitated on the condensation cooler as liquid. According to the invention, the condensation cooler is put into rotation at a rotational speed so that the resulting centrifugal force conveys precipitation which condenses on the condensation cooler radially outward to the edge of the condensation cooler, and throws it off radially from there.

According to still another embodiment of the invention, in the condensation cooler, walls of multiple chambers, which are in flow connection to each other, are cooled on one side by a cooling medium, and used on the other side as condensation surfaces for the steam from the constant-pressure turbine. According to the invention, the environmental conditions (pressure, temperature, temperature at the walls of the condensation cooler, etc.) are set so that the steam is precipitated at a dew point of about 120° C.-140° C., preferably about 130° C., on the walls of the condensation cooler.

According to still another embodiment of the invention, precipitation which is thrown off radially from the edges of the chambers of the condensation cooler is collected as liquid in a depression, so that this liquid is available as heat exchanger fluid for feeding into the output-side inlet of the heat exchanger.

The chamber walls of the condensation cooler are cooled by a cooling medium below the dew point of the steam escaping from the constant-pressure turbine, and the thermal energy of this cooling medium is conducted out of the device via a further heat exchanger.

From the depression, by means of a feed pump, e.g. a gear pump or another type of positive-displacement pump, the liquid is conveyed as heat exchanger fluid to the output-side inlet of the heat exchanger.

To generate electrical energy, as the electrical generator a reluctance generator or a permanent-magnet direct current generator, preferably with electronic commutation, is used. According to the invention, the direct current generator is capable of processing relatively high rotational speeds (approx. 80,000-approx. 160,000 revolutions per minute, preferably approx. 120,000 revolutions per minute), since steam flows from the Laval nozzle to the constant-pressure turbine at a very high velocity (several times the speed of sound). In the constant-pressure turbine, the energy of the steam is optimally exploited when its blades move half as fast as the steam flows out of the Laval nozzle. The turbine blade wheel of the constant-pressure turbine therefore has a circumferential speed of about half the speed at which steam flows out of the Laval nozzle.

Further details, modifications and properties of the invention are explained below with reference to the figures.

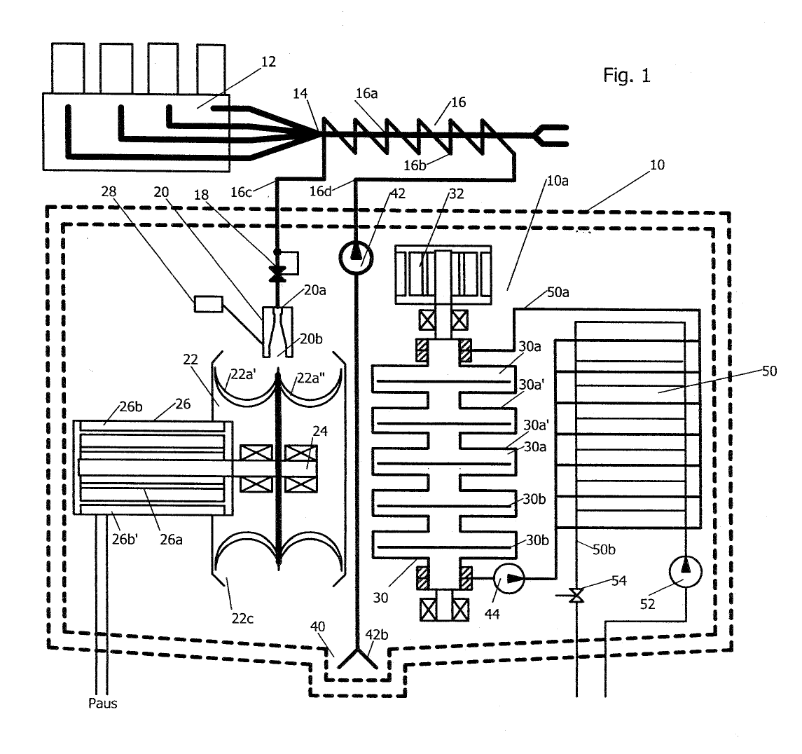

FIG. 1 shows a schematic overview representation of a device according to the invention for recovering electrical energy from the exhaust heat of a combustion engine of a motor vehicle;

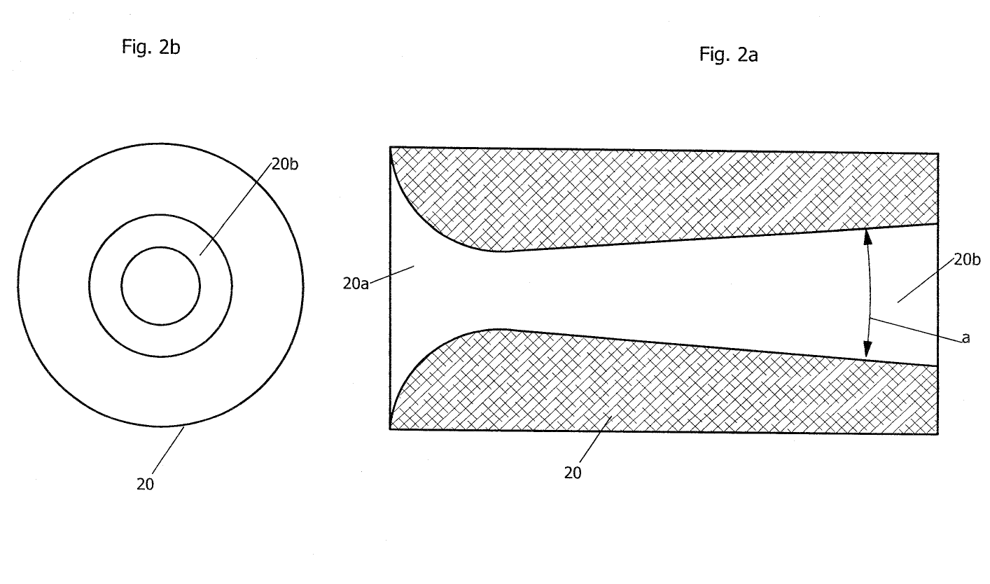

FIG. 2a shows a Laval nozzle in a schematic longitudinal section representation; and

FIG. 2b shows the Laval nozzle from FIG. 2a in a schematic front view.

### DETAILED DESCRIPTION OF PREFERRED EMBODIMENTS OF THE INVENTION

FIG. 1 shows a device for recovering electrical energy from the exhaust heat of a combustion engine 12 of a motor vehicle (not otherwise shown). The device is held in a pressure-resistant and temperature-resistant jacket 10. The combustion engine 12 can be a diesel engine, a petrol engine, or similar. On a (common) exhaust pipe 14 of the exhaust system of the combustion engine 12, a heat exchanger 16 is arranged. The heat exchanger 16 has an input-side pipe 16a, through which exhaust gas of the combustion engine 12 flows when the combustion engine 12 is operating. In the exhaust pipe 14 of the exhaust system, in the section which forms the input-side pipe 16a of the heat exchanger 16, to improve the heat transfer (not otherwise shown), (longitudinal) ribs, which are formed on the inner wall of the exhaust pipe 14, can be provided.

The heat exchanger 16 has an output-side pipe 16b, which is wound around the input-side pipe 16a of the heat exchanger 16, and is thus in temperature-conducting contact with the input-side pipe 16a of the heat exchanger 16. In operation of the device, heat exchanger fluid, e.g. water, flows through the output-side pipe 16b. For this purpose, the heat exchanger 16 must be connected to the combustion engine 12 of the motor vehicle, and the heat exchanger fluid must flow through the heat exchanger, in such a way that the exhaust gas of the combustion engine and the heat exchanger fluid pass through the heat exchanger 16 in counter-flow. In operation of the combustion engine 12, the heat exchanger fluid is brought in the heat exchanger 14 to high temperature and pressure levels of about 450° C. to 700° C. and about 45 bar to about 70 bar. To reach these temperature and pressure levels as quickly as possible, the heat exchanger 16 has, connected downstream on its output-side outlet 16c, a control valve 18 which switches depending on pressure and/or temperature, and which below the predetermined first pressure and/or temperature level is in its closed position. Only when a temperature level of the heat exchanger fluid of about 450° C. to 700° C. and/or a pressure level of about 45 bar to about 70 bar is reached, the control valve 18 switches from its closed position to its open position. Thus a flow path for the heat exchanger fluid, which at the above-mentioned high pressure and/or temperature level is present as superheated steam, is routed to an inlet 20a of a Laval nozzle 20.

The Laval nozzle 20 has an outlet 20b, which is directed onto blades 22a′, 22a″ of a constant-pressure turbine 22. The Laval nozzle 20 is in such a form that it loads the constant-pressure turbine 22 with steam which escapes at the outlet 20b of the Laval nozzle 20, and which has a lower, second pressure level of about 2-7 bar, and/or a lower, second temperature level of about 150-200° C., and a flow speed of about 900-1300 m/s.

The Laval nozzle 20 is dimensioned so that the steam which is fed in at its inlet 20a is also superheated steam at the outlet 20b of the Laval nozzle 20.

The Laval nozzle 20 (see also FIGS. 2a, 2b) has an essentially circular cross-section, the outlet 20b of the Laval nozzle 20 having an expansion angle a which is chosen so that the escaping steam has a flow with no separation. Depending on the chosen heat exchanger fluid, this is the case with an expansion angle a of under about 20°, in the case of water preferably under about 10°.

The constant-pressure turbine 22 is in the form of a Pelton turbine which has a tangential flow through it, and which has a turbine blade wheel 22a with blades 22a′, 22a″ arranged adjacently to each other. The turbine blade wheel 22a is put into rotation by the steam directed onto its blades 22a′, 22a″, a torque being caused in a turbine shaft 24. The turbine shaft 24 is coupled to a rotor 26a of an electrical generator 26 for co-rotation. By being put into rotation, practically all the kinetic energy is drawn from the steam, if the blades 22a′, 22a″ move half as fast as the steam flows out of the Laval nozzle 20. A pressure difference between the inlet 20a of the Laval nozzle 20 and an outlet 22c of the constant-pressure turbine 22 must be relieved practically exclusively in the Laval nozzle 20, while the pressure in the turbine blade wheel 22a remains practically constant. The constant-pressure turbine 22 is arranged within the jacket 10 so that its blades 22a′, 22a″ are free of tailwater.

The electrical generator 26 has a stator 26b which surrounds the rotor 26a, with multiple stator windings 26b″. When the constant-pressure turbine 22 puts the rotor 26a, which is coupled to it, of the electrical generator 26 into rotation, electrical power Pₐᵤₛ can be tapped at its stator winding 26b′.

To regulate the useful electrical power Pₐᵤₛ which is tapped at the stator winding 26b′ by changing the volume flow, the Laval nozzle 20 can have a nozzle cross-section which can be adjusted with an adjustment device 28 (merely indicated).

The device also has a condensation cooler 30 (see also FIG. 3), which is set up to liquefy steam which has done work on the constant-pressure turbine 22.

For this purpose, the condensation cooler 30 is in the form of a body which is to be put into rotation by an electric motor 32. This body 30 is arranged within the jacket 10, in a space 10a or region which the steam reaches after it has done work on the constant-pressure turbine 22. More precisely, the condensation cooler 30 has multiple circular disc-shaped chambers 30a which are connected to each other for flow, and the walls 30a′ of which must be cooled on one side (the inside in FIG. 1) by a cooling medium, and on the other side (the outside in FIG. 1) are used as condensation surfaces for the steam from the constant-pressure turbine 22. The circular disc-shaped chambers 30a are stacked one on top of or on one another, aligned axially in the region of their central longitudinal axes, and joined to each other in a pressure-tight manner. Additionally, within the chambers 30a, baffle plates 30b for the cooling medium, e.g. water or hydrocarbons (alcohol, oil or similar) are provided. Instead of the circular disc-shaped chambers 30a, other shapes of chamber are possible. The chambers 30a of the condensation cooler 30 must be put into rotation by the electric motor 32, at a rotational speed such that the resulting centrifugal force conveys precipitation (of the steam) which condenses on the condensation surface radially outward to the edges of the chambers 30a, and throws it off radially from there.

At the base within the jacket 10, a depression 40 is provided, to collect precipitation which is thrown off radially from the edges of the chambers 30a as liquid. This liquid is then available as heat exchanger fluid for feeding into the output-side inlet 16d of the heat exchanger 16 by means of the pump 42. An intake 42a of the feed pump 42 extends into the depression 40, to convey the liquid to the output-side inlet 16d of the heat exchanger 16.

To cool the chamber walls 30a′ of the condensation cooler 30, the cooling medium is conveyed through the condensation cooler 30 along the chamber walls, by means of an electric pump 44. The thermal energy of this cooling medium which is conveyed out of the condensation cooler 30 is fed to the input side 50a of a further heat exchanger in the form of a plate heat exchanger 50, the output side 50b of which is guided out of the device 10. For this purpose, a further electric pump 52, which conveys the volume flow of the output side 50b of the plate heat exchanger 50, is provided within the jacket 10. The temperature and pressure conditions within the device 10 must also be set by controlling or regulating the amount of thermal energy (waste heat) which is transported out of the inside of the jacket 10. For this purpose, in the flow path of the output side 50b of the plate heat exchanger 50, a control valve 54 is arranged. The control valve 54 opens the flow path of the output side 50b of the plate heat exchanger 50 from a predetermined maximum pressure (e.g. 2-5 bar) and/or a predetermined maximum temperature (110-130° C.) within the device 10.

Operation of the device described above is managed by an electronic controller (not otherwise shown), which supplies control current to the pumps, valves, motors etc. depending on (temperature/pressure) sensors within the device, and on power requirement signals from the load to which useful power Pₐᵤₛ is supplied.

1. A device for recovering electrical energy from the exhaust heat of a combustion engine (12) of a motor vehicle, with
a heat exchanger (16), through which
the exhaust gas of the combustion engine (12) is to flow on the input side, and through which
heat exchanger fluid, which in operation of the combustion engine (12) is to be brought in the heat exchanger (16) to a first, high temperature and/or pressure level, is to flow on the output side,
at least one Laval nozzle (20), which has an inlet (20a) and an outlet (20b),
the inlet (20a) of which is to be connected to an output-side outlet (16c) of the heat exchanger (16), with a control valve (18), which switches depending on pressure and/or temperature, connected between them, the control valve (18) being in its closed position below a predetermined first pressure and/or temperature level.
the outlet (20b) of which is directed onto at least one turbine blade wheel (22a) of a constant-pressure turbine (22), and
which is dimensioned so that it loads the constant-pressure turbine (22) with steam which has a lower second temperature and/or pressure level than the first, high temperature and/or pressure level and has a high flow velocity, an electrical generator (26), which
has a rotor (26a) which is coupled to the constant-pressure turbine (22) and is to be put into rotation by it, and
a stator (26b) with at least one stator winding (26b′), at which electrical power (Pₐᵤₛ) is to be taken, and
a condensation cooler (30), which is set up to liquefy steam which has done work on the constant-pressure turbine (22), liquid which is obtained from this steam by condensation having to be fed into an output-side inlet (16d) of the heat exchanger (16).

2. A device for recovering electrical energy according to claim 1, characterized in that the combustion engine (12) of the motor vehicle is an internal combustion engine (12) in the form of a diesel engine, a petrol engine or similar.

3. A device for recovering electrical energy according to claim 1, characterized in that the heat exchanger (16) must be connected to the combustion engine (12) of the motor vehicle, and the heat exchanger fluid must flow through the heat exchanger (16), in such a way that the exhaust gas of the combustion engine (12) and the heat exchanger fluid pass through the heat exchanger (16) in counter-flow.

4. A device for recovering electrical energy according to claim 3, characterized in that the inlet (20a) of the Laval nozzle (22) must be connected to the output-side outlet (16c) of the heat exchanger (16),

5. A device for recovering electrical energy according to claim 1, characterized in that the Laval nozzle (20) has an essentially circular cross-section, the outlet (20b) of the Laval nozzle (20) having an expansion angle (a) which is chosen so that the escaping steam has a flow with no separation, the expansion angle (a) being under 20°, preferably under about 10°.

6. A device for recovering electrical energy according to claim 1, characterized in that the Laval nozzle (20) is dimensioned so that the steam which is fed into its inlet (20a) is superheated steam (dry steam) at the outlet (20b) of the Laval nozzle (20).

7. A device for recovering electrical energy according to claim 1, characterized in that the constant-pressure turbine (22) has a turbine blade wheel (22a), which to generate a torque which acts on the rotor (26a) of the electrical generator (26) draws energy from the steam, and a pressure difference between the inlet (20a) of the Laval nozzle (20) and an outlet (22c) of the constant-pressure turbine (22) must be relieved practically exclusively in the Laval nozzle (20), while the pressure in the turbine blade wheel (22a) remains substantially constant.

8. A device for recovering electrical energy according to claim 1, characterized in that the constant-pressure turbine is a Pelton turbine (22), and the flow through it is preferably tangential.

9. A device for recovering electrical energy according to claim 1, characterized in that useful electrical power is regulated by changing the volume flow, wherein the Laval nozzle (20) has a nozzle cross-section which can be adjusted with an adjustment device (28).

10. A device for recovering electrical energy according to claim 1, characterized in that the constant-pressure turbine (20) is arranged so that its blades (22a′, 22a″) are free of tailwater.

11. A device for recovering electrical energy according to claim 1, characterized in that the condensation cooler (30) is in the form of a body which is to be put into rotation, and which is arranged in a space (10a) which the steam reaches after it has done work on the constant-pressure turbine (22).

12. A device for recovering electrical energy according to claim 11, characterized in that the condensation cooler (30) is to be put into rotation by a motor (32).

13. A device for recovering electrical energy according to claim 12, characterized in that the condensation cooler (30) has multiple chambers (30a) which are connected to each other for flow, and walls (30a′) of said chambers are cooled on one side by a cooling medium, and on the other side are used as condensation surfaces for the steam from the constant-pressure turbine (22).

14. A device for recovering electrical energy according to claim 13, characterized in that the chambers (30a) must be put into rotation at a rotational speed such that the centrifugal force conveys precipitation which condenses on the condensation surface radially outward to the edges of the chambers (30a), and throws it off radially from there.

15. A device for recovering electrical energy according to claim 14, characterized in that a depression (40) is provided, to collect precipitation which is thrown off radially from the edges of the chambers (30a) as liquid, so that it is available as heat exchanger fluid for feeding into the output-side inlet (16d) of the heat exchanger (16).

16. A device for recovering electrical energy according to claim 15, characterized in that to cool the chamber walls (30a) of the condensation cooler (30), a cooling medium must be conveyed along the chamber walls (30a′), the thermal energy of this cooling medium being conducted out of the device via a further heat exchanger (50).

17. A device for recovering electrical energy according to claim 16, characterized in that an intake (42b) of a feed pump (42) extends into the depression (40), to convey the liquid to the output-side inlet (16c) of the heat exchanger (16).

18. A device for recovering electrical energy according to claim 1, characterized in that an electronic controller, which supplies control current to the pumps, valves, etc. depending on sensors within the device, is provided to operate the components of the device.

19. A device for recovering electrical energy according to claim 1, characterized in that the electrical generator (26) is a reluctance generator or a permanent-magnet direct current generator, preferably with electronic commutation.

20. A device for recovering electrical energy according to claim 1, characterized in that the device is held in a pressure-resistant and temperature-resistant jacket (10).

21. A condensation cooler, with cooling surfaces which must be put into rotation by a rotation drive so that a medium which they condense is thrown off by centrifugal force, the condensation cooler having multiple chambers which are connected to each other for flow, and the walls of which must be cooled on one side by a cooling medium, and on the other side are used as condensation surfaces for steam.

22. A method for recovering electrical energy from the exhaust heat of a combustion engine of a motor vehicle, with the following steps:
providing a heat exchanger,
feeding exhaust gas of the combustion engine into the input side of the heat exchanger,
feeding heat exchanger fluid into the output side of the heat exchanger, to bring the heat exchanger fluid in the heat exchanger to a first, high temperature and/or pressure level in operation of the combustion engine, feeding the heat exchanger fluid at the first, high temperature and/or pressure level to at least one Laval nozzle, which has an inlet for the heat exchanger fluid and an outlet which is directed onto turbine blade wheels of a constant-pressure turbine,
the heat exchanger fluid not being fed to the Laval nozzle until the heat exchanger fluid is above a predetermined first pressure and/or temperature value,
the Laval nozzle being dimensioned so that it loads the constant-pressure turbine with steam which has a lower second temperature and/or pressure level than the first, high temperature and/or pressure level and has a high flow velocity,
to put a rotor (of an electrical generator) which is coupled to the constant-pressure turbine into rotation, and to take electrical power from a stator of the electrical generator with at least one stator winding,
condensing the steam which has done work on the constant-pressure turbine using a condensation cooler, and
feeding the liquid which is obtained by condensing this steam into the output side of the heat exchanger as heat exchanger fluid.

23. A method according to claim 22, characterized in that as the combustion engine of the motor vehicle, an internal combustion engine in the form of a diesel engine, a petrol engine or similar is used.

24. A method according to claim 22, characterized in that the exhaust gas of the combustion engine and the heat exchanger fluid pass through the heat exchanger in counter-flow.

25. A method according to claim 22, characterized in that the inlet of the Laval nozzle is not put into flow connection to the output-side outlet of the heat exchanger until the heat exchanger fluid has reached a pressure level of about 450° C. to 700° C., or a temperature level of about 45 bar to about 70 bar.

26. A method according to claim 25, characterized in that at the outlet of the Laval nozzle, steam is provided essentially in a flow with no separation.

27. A method according to claim 26, characterized in that at the outlet of the Laval nozzle superheated steam, which preferably has a pressure of about 2-7 bar, a temperature of about 150-200° C., and a flow velocity of about 900-1300 m/s, is provided.

28. A method according to claim 22, characterized in that to generate a torque which acts on the rotor of the electrical generator, a turbine blade wheel of the constant-pressure turbine draws energy from the steam, and a pressure difference between the inlet of the Laval nozzle and an outlet of the constant-pressure turbine is relieved practically exclusively in the Laval nozzle, while the pressure in the turbine blade wheel remains practically constant.

29. A method according to claim 22, characterized in that the steam which the Laval nozzle provides preferably flows through the constant-pressure turbine tangentially.

30. A method according to claim 22, characterized in that to regulate a useful electrical power which the device outputs, the volume flow through the nozzle cross-section of the Laval nozzle is adjusted with an adjustment device.

31. A method according to claim 30, characterized in that after the steam has done work on the constant-pressure turbine, it is precipitated on the condensation cooler as liquid, the condensation cooler being put into rotation at a rotational speed so that the resulting centrifugal force conveys precipitation which condenses on the condensation cooler radially outward to the edge of the condensation cooler, and throws it off radially from there.

32. A method according to claim 22, characterized in that the condensation cooler has walls of multiple chambers, which are in flow connection to each other, and are cooled on one side by a cooling medium, and used on the other side as condensation surfaces for the steam from the constant-pressure turbine.

33. A method according to claim 32, characterized in that precipitation which is thrown off radially from the edges of the chambers of the condensation cooler is collected as liquid in a depression, so that this liquid is available as heat exchanger fluid for feeding into the output-side inlet of the heat exchanger.

34. A method according to claim 32, characterized in that the chamber walls of the condensation cooler are cooled by a cooling medium below the dew point of the steam escaping from the constant-pressure turbine, and the thermal energy of this cooling medium is conducted out of the device via a further heat exchanger.

35. A method according to claim 33, characterized in that from the depression, by means of a feed pump, the liquid is conveyed as heat exchanger fluid to the output-side inlet of the heat exchanger.

36. A method according to claim 22, characterized in that to generate electrical energy, as the electrical generator a reluctance generator or a permanent-magnet direct current generator, preferably with electronic commutation, is used.
